(19) United States
(12) Patent Application Publication
(10) Pub. No.: US 2025/0324236 A1
(43) Pub. Date: Oct. 16, 2025

(54) PROVIDING A PROFILE PACKAGE ON A PROFILE SERVER FOR DOWNLOAD TO AN EUICC

(71) Applicant: GIESECKE+DEVRIENT MOBILE SECURITY GERMANY GMBH, Munchen (DE)

(72) Inventors: Ulrich HUBER, Munchen (DE); Zofia DOMANSKA, Rio de Janeiro (BR)

(21) Appl. No.: 18/866,385

(22) PCT Filed: May 23, 2023
(86) PCT No.: PCT/EP2023/025237

§ 371 Date: Nov. 15, 2024

(30) Foreign Application Priority Data
May 25, 2022 (EP) 22175542.4

(51) Int. Cl. H04W 8/20; H04W 12/06; H04W 12/08

(52) U.S. Cl. CPC H04W 8/20; H04W 12/06; H04W 12/08

(57) ABSTRACT

A method is for providing a profile package for download from a profile server to an eUICC, the method releasing a linked ICCID and generating new network credentials for profile download.

### FIELD OF THE INVENTION

The present invention relates to providing a profile package on a profile server, for download of the profile package from the profile server to an eUICC, and a profile download method.

### BACKGROUND OF THE INVENTION AND PRIOR ART

Mobile devices host at least one eUICC comprising one or several profiles allowing the mobile device to authenticate itself versus a mobile network, so as to establish and run a communication session in the mobile network, for example a voice call or data transmission.

Document [1] [SGP.22 V2.2.2], GSMA SGP.22-SGP.22 RSP Technical Specification, Version 2.2.2, 5 Jun. 2020 (2020-06-05) from the prior art is concerned with the Remote SIM Provisioning, which is understood to be the downloading, installing, enabling, disabling, and deleting of a profile on an embedded universal integrated circuit card, eUICC.

For establishing and running the communication session in the mobile network under a particular profile, the profile comprises a set of identifiers, like IMSI and Ki. In addition to the identifiers, the profile contains OTA Keys (OTA=over-the-air), also called network credentials, used in conjunction with the communication between the eUICC and OTA platforms. An OTA platform is understood as an Operator platform for remote management of UICCs and the content of Enabled Operator Profiles on eUICCs. Herein, an Operator is understood as a Mobile Network Operator, MNO, or Mobile Virtual Network Operator, MVNO, or generally a company providing wireless cellular network services.

The document [2] [PP], SIM Alliance, eUICC Profile Package: Interoperable Format Technical Specification, Version 2.3, October 2019, defines the contents and formats of elements of a Profile Package used to download a profile to an eUICC. The profile contains its content in form of Profile Elements, PEs. Annex A of [2] shows a template Profile Package showing the mandatory elements of a Profile Package. According to [2] 9.2, a Profile Package contains a profile number, “Integrated Circuit Card Identifier”, ICCID. According to [2] 9.5, an USIM Profile Package of GSM type 4G or lower contains an Elementary File EF containing an International Mobile Subscriber Identity, IMSI and an Elementary File, EF containing Keys, or in case of an ISIM or CSIM Profile Package similar Elementary files, EFs. A 5th Generation, 5G, profile contains a Subscription Permanent Identifier, SUPI, containing the IMSI.

Document [1] [SGP.22 V2.2.2], GSMA SGP.22-SGP.22 RSP Technical Specification, Version 2.2.2, 5 Jun. 2020 (2020-06-05) from the prior art, taking into account mobile networks of the generations up to 4th generation, 4G, discloses a standard set of profile identifiers that comprises or consists of the authentication key Ki and the identifier International Mobile Subscriber Identity IMSI. In mobile networks of the generation 5G, the set of profile identifiers comprises a SUPI as an analogue element to the IMSI, and it is used for entering into and running communication sessions in the mobile network in a concealed form as SUCI.

Document [1] [SGP.22 V2.2.2], particularly chapter 3.1.3 “Profile Download and Installation”, is concerned with the process of downloading profiles from a profile server, in document [1] the SM-DP+, to an eUICC.

Document [1] [SGP.22 V2.2.2], particularly chapter 3.1.1 “Profile Download Initiation”, is also concerned with the process of ordering a profile by a connectivity service provider CSP, in [1] called the Operator and assumed to be a Mobile Network Operator MNO, at a profile server, in [1] called the SM-DP+.

Present FIG. 2 represents FIG. 9 from document [1] [SGP.22 V2.2.2], chapter 3.1.1 “Profile Download Initiation”. [1] [SGP.22 V2.2.2], FIG. 9, and the related text of chapter 3.1.1 describe the procedure of ordering a profile by an Operator at a profile server SM-DP+. In a step (1), the Operator sends to the SM-DP+ a profile download order via a channel ES2+, by a command ES2+.DownloadProfile (EID, Profile Type or ICCID). The profile download command indicates an EID (EID=identifier of the eUICC hardware) of a target eUICC, and either a Profile Type or a distinct profile number ICCID. According to [1], 3.1.1.2, description of step (1), if ICCID is given, the SM-DP+ SHALL verify that this ICCID is available. In case that the Operator orders a profile, giving in the profile download order a distinct ICCID, and the SM-DP+ realizes that the ICCID is assigned to a profile that is already downloaded to some eUICC, then the SM-DP+ rates the ICCID as not available, and doesn't fulfil the profile download order without further measures. The measures to be taken are not further specified in the SGP.22 specification [1] [SGP.22 V2.2.2].

An at least internally know solution to release an ICCID of an already downloaded profile, so as to make it an available ICCID, is to delete the profile from its download location in an eUICC, and to provide a profile delete notification from the eUICC to the SM-DP+. Upon receipt of the profile delete notification, the SM-DP+ releases the ICCID as available, the profile download order referring to the ICCID is approved (provided no other restraints exist), and the profile can be downloaded to the target eUICC indicated in the profile download order. The target eUICC can be the same or a different eUICC as compared to the eUICC where the profile was deleted.

Another known solution to circumvent a linked (locked) ICCID is to order a new profile containing a new identifier IMSI and being assigned a new profile number ICCID. Each IMSI and ICCID of a profile ready to be used in a mobile network have to be registered in the home location register HLR of the MNO hosting the profile. The MNO charges a fee for each IMSI and ICCID registered in its HLR. Therefore, having multiple IMSIs and ICCIDs registered at the MNOs HLR is costly.

Some IMSIs or ICCIDs or IMSI/ICCID pairs in the field are linked (locked) even though they are not used any more. For example, a user may discontinue to use its old device (e.g. lay it away in in a drawer), including the eUICC hosted in the device, and take no further action about the device/eUICC, particularly not delete any profile(s) from the eUICC. In this situation, the IMSI or ICCID or IMSI/ICCID pair(s) of the profile(s) on the eUICC stay linked (locked), in worst case forever.

Another use case is profile users owning several mobile devices might want to use copies of their profiles on their several devices, without having to delete profiles on any of the devices, and without having to make use of several IMSIs and/or ICCIDs. Currently, if a user wants to download the same profile for a second time, however, the same profile credentials for network access are used, and download of the profile for a second time is possible only if the profile server receives a profile delete notification for the already downloaded profile.

### OBJECTIVE OF THE INVENTION

It is an object of the present invention to provide a flexible, efficient and secure profile download solution allowing to use or re-use linked (locked) profile numbers, such as ICCIDs.

### SUMMARY OF THE INVENTION

In greater detail, the object of the invention is achieved by a method with the following features, according to claim 1. Embodiments of the invention are presented in dependent claims.

The method for providing a profile package for download from a profile server to an eUICC hosted in a mobile device comprising the steps at the profile server:
a) receive, from a connectivity service provider server, a profile download order containing a profile type, or a profile number;
b) generate a profile package comprising profile credentials and a profile number assigned considering the received profile type, or the received profile number; the profile credentials are preferably as usual for a profile;
c) provide the generated profile package for download to an eUICC.

The method is characterized by the steps:
a1) identify the received or assigned profile number as linked to a profile already downloaded to an eUICC;
   a2) receive, from the connectivity service provider server, a notification that the linked profile number is allowable for release, the allowability for release being due to fulfilling a release criteria; herein, preferably, the connectivity service provider server verifies at its end the release criteria, and notifies the profile server of the result of the verification, namely that the profile number is allowable for release;
a3) the profile server releases the linked profile number;
a4) the profile server generates network access credentials to be used for downloading the generated profile package to the eUICC.

By the thus achieved method, a linked profile number, when it fulfils release criteria, can be re-used for a new profile download. A linked profile number is a profile number which is occupied since a profile is downloaded to some eUICC using said profile number. Due to the generation of (new) network credentials, an eUICC and background infrastructure that made use of the same profile number in the past to download a profile to an eUICC, have no access to the new profile download process. Thus, even though using the same profile number, confidentiality and security of the profile download is assured, due to the (new) generated network credentials. Since the profile number is released on-the-fly, when it is needed, the method is particularly flexible and efficient.

The release criteria can comprise one or several of the following:
(1) The profile number hasn't been used in any authentication request received at the connectivity service provider server from any mobile device or eUICC for a predetermined time period or longer, where the time period can be e.g. one year, as a non-limiting example. In this case, release of the profile number implies that use of the profile number is discontinued for the profile to which is was linked before the release. The release thus swaps the profile number from an old profile to a new profile, the same number of profiles (e.g. one) being assigned to the profile number before and after the release of the profile number.
(2) The profile number is scheduled to be used for two or more copies of the same profile scheduled to be held available in parallel on two or more different mobile devices or/and on two or more different eUICCs. In This case, the released profile number can continue to be in use also for the profile to which the profile number was linked before the release. The release of the profile number thus effects to add an additional profile to the same profile number.

The network access credentials can comprise one or several of the following:—OTA keys;—NAA parameters;—AKA parameters for MILENAGE or TUAK or a proprietary authentication algorithms. The network access credentials are designed to enable secure and confidential profile download from a profile server to an eUICC via a network.

The network access credentials preferably differ from network access credentials which have been generated for the profile already downloaded to an eUICC.

The connectivity service provider may be either one or several of:
a Mobile Network Provider, e.g. an MNO;
a Mobile Virtual Network Provider, e.g. an MVNO.

Step a2) may comprise following sub-steps:
a2-1) send a download order response to the connectivity service provider server, informing the connectivity service provider server of the linked profile number, and requesting the connectivity service provider server to release the linked profile number;
a2-2) receive from the connectivity service provider server a confirm order that the linked profile number is allowable to be released;
a2-3) release the linked profile number at the profile server.

The profile which is already downloaded to an eUICC may comprise a profile identifier, such as IMSI, wherein the profile package of step b) may comprise the same profile identifier, e.g. IMSI, as the profile which is already downloaded to an eUICC. This embodiment of the invention allows to re-use as well a profile number, such as ICCID, as also the profile identifier, such as IMSI, and is particularly useful when downloading the same profile to a further device of the same user. In other use cases, for example when an expired profile number, e.g. ICCID, shall be re-used, the profile identifier, e.g. IMSI, of the new usage will usually be different from the profile identifier, e.g. IMSI, of the previous usage.

The profile download order of step a) may further contain an eUICC hardware identifier, e.g. EID, of a eUICC to which the profile package shall be downloaded.

A method for downloading a profile to an eUICC comprises the steps:
provide a profile package on a profile server by a method as described above;
download the provided profile package from the profile server to the eUICC, herein using the generated network access credentials.

Preferably, the generated network access credentials haven't been used for a profile download before.

A profile server according to the present invention is implemented to perform a method as described above.

### BRIEF DESCRIPTION OF THE DRAWINGS

Embodiments of the invention will now be described with reference to the accompanying drawings, throughout which like parts are referred to by like references, and in which represents:

FIG. 1 a diagram depicting profile ordering, including releasing a linked ICCID, according to an embodiment of the invention;

FIG. 2 a diagram of a Remote SIM Provisioning architecture, according to SGP.22 V2.2.2, FIG. 1, suitable for implementation of the invention.

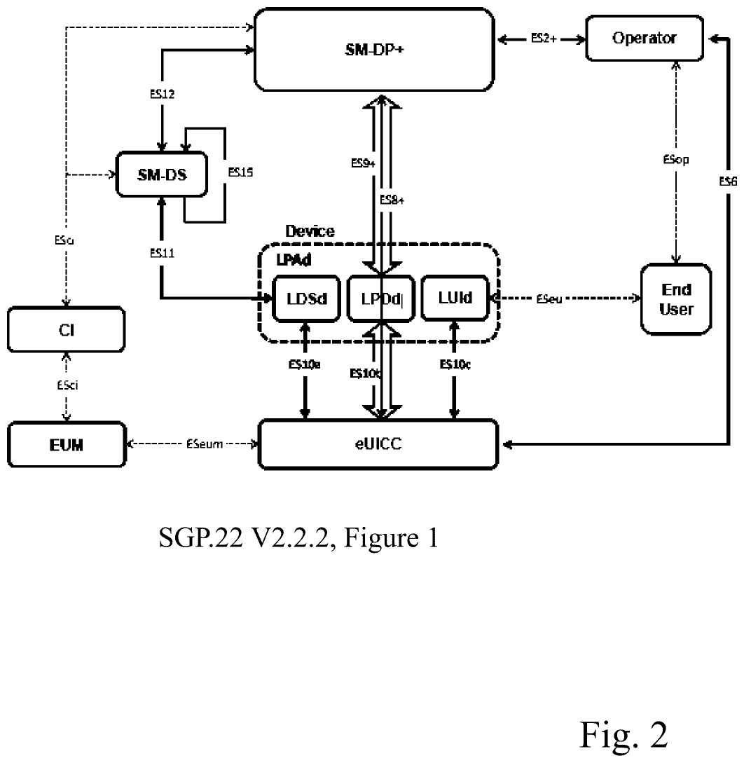

### DETAILED DESCRIPTION OF THE INVENTION

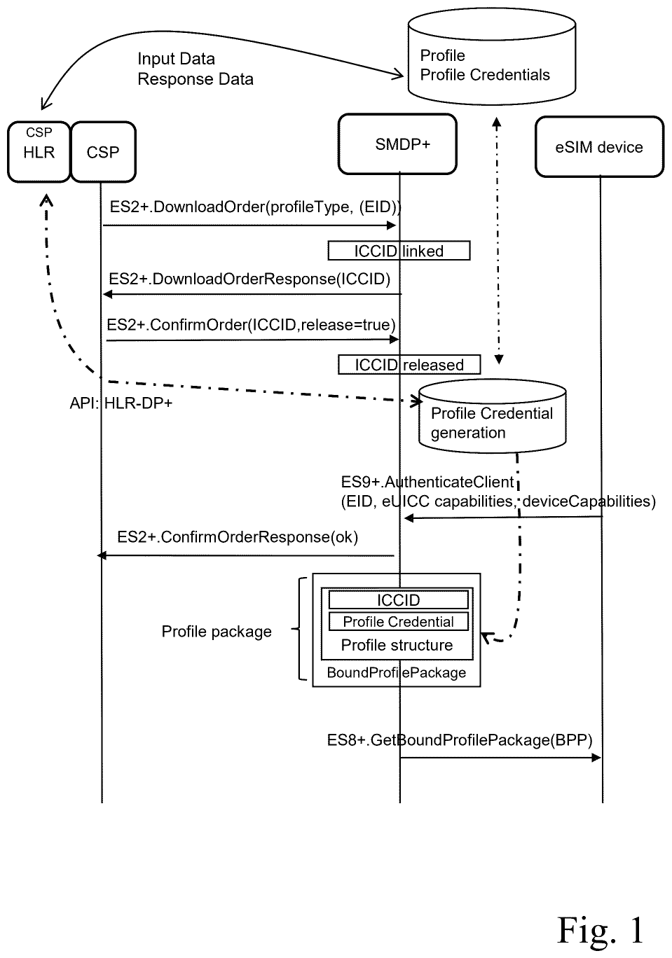

FIG. 1 shows a diagram depicting profile ordering and delivery from a profile server SMDP+ to an eUICC hosted in an esim device, herein releasing a linked profile number ICCID, according to an embodiment of the invention.

A connectivity service provider server CSP sends to the profile server SMDP+, over the channel ES2+, a download order for a profile. The download order contains a profile type, and optionally an eUICC hardware identifier, EID, of a eUICC to which the profile package shall be downloaded.

The profile server SMDP+ checks the profile type and assigns to the profile order a profile number ICCID which is compliant with the profile type. In addition, the profile server SMDP+ identifies that the assigned profile number ICCID is not free, but is linked to a profile resident in an eUICC already.

The profile server SMDP+ sends to the connectivity service provider server CSP, over the channel ES2+, a notification that the assigned profile number ICCID is linked to a profile resident in an eUICC.

The connectivity service provider server CSP checks the ICCID, finds it is free for release according to a release criteria, and sends to the profile server SMDP+, over the channel ES2+, a notification that the assigned profile number ICCID is allowable for release.

In reaction to receipt from the connectivity service provider CSP of the notification that the assigned profile number is allowable for release, the profile server SMDP+ releases the profile number ICCID. In addition, the profile server SMDP+ generates network credentials. The generated network credentials are normally different from network credentials that were generated when the ICCID was used previously in connection with the already downloaded profile, for example due to the use of random number generation during generation of the network credentials. It is essential, however, that no already present, and previously used for profile download, network credentials are re-used, but new network credentials are generated.

The profile server SMDP+ generates profile credentials.

Authentication via channel ES9+ between the profile server SMDP+ and the esim device is performed. The connectivity service provider is notified via channel ES2+.

The profile server SMDP+ generates a profile package. The profile package contains the ICCID, the profile structure, the generated profile credentials. The profile server generates a Bound Profile Package from the profile package.

The SMDP+ uses the new generated network credentials to download the Bound Profile Package to the eUICC hosted in the esim device, via channel ES8+.

### CITED PRIOR ART DOCUMENTS

[1] [SGP.22 V2.2.2] GSMA SGP.22-SGP.22 RSP Technical Specification, Version 2.2.2, 5 Jun. 2020 (2020-06-05)

[2] [PP], SIM Alliance, eUICC Profile Package: Interoperable Format Technical Specification, Version 2.3, October 2019

1.-11. (canceled)

12. A method for providing a profile package for downloading from a profile server to an eUICC hosted in a mobile device, the method comprising the steps at the profile server:
a) receive, from a connectivity service provider server, a profile download order containing a profile type, or a profile number;
b) generate a profile package comprising profile credentials and a profile number assigned considering the received profile type, or the received profile number;
c) provide the generated profile package for download to an eUICC;
wherein the steps:
a1) identify the received or assigned profile number as linked to a profile already downloaded to an eUICC;
a2) receive, from the connectivity service provider server, a notification that the linked profile number is allowable for release, the allowability for re-lease being due to fulfilling a release criteria;
a3) release the linked profile number;
a4) generate network access credentials to be used for downloading the generated profile package to the eUICC.

13. The method according to claim 12, wherein the release criteria comprises one or several of the following:
the profile number hasn't been used in any authentication request received at the connectivity service provider server from any mobile device or eUICC for a predetermined time period or longer;
the profile number is scheduled to be used for two or more copies of the same profile scheduled to be held available in parallel on two or more different mobile devices or/and on two or more different eUICCs.

14. The method according to claim 12, wherein the network access credentials comprise one or several of the following:
OTA keys
NAA parameters
AKA parameters for MILENAGE or TUAK or a proprietary authentication algorithms.

15. The method according to claim 12, wherein the network access credentials differ from network access credentials which have been generated for the profile already downloaded to an eUICC.

16. The method according to claim 12, wherein the connectivity service provider is either one or several of:
a Mobile Network Provider;
a Mobile Virtual Network Provider.

17. The method according to claim 12, wherein step a2) comprises following sub-steps:
a2-1) send a download order response to the connectivity service provider server, informing the connectivity service provider server of the linked profile number and requesting the connectivity service provider server to release the linked profile number;
a2-2) receive from the connectivity service provider server a confirm order that the linked profile number is allowable to be released;
a2-3) release the linked profile number at the profile server.

18. The method according to claim 12, wherein the profile which is already downloaded to an eUICC comprises a profile identifier,
wherein the profile package of step b) comprises the same profile identifier as the profile which is already downloaded to an eUICC.

19. The method according to claim 12, the profile download order of step a) further containing an eUICC hardware identifier of a eUICC to which the profile package shall be downloaded.

20. A method for downloading a profile to an eUICC, comprising the steps:
provide a profile package on a profile server by a method according to claim 12;
download the provided profile package from the profile server to the eUICC, herein using the generated network access credentials.

21. The method according to claim 20, wherein the generated network access credentials haven't been used for a profile download, particularly haven't been used for a profile download before the download.

22. A profile server implemented to perform a method according to claim 12.
